(19) United States
(12) Patent Application Publication
(10) Pub. No.: US 2024/0352744 A1
(43) Pub. Date: Oct. 24, 2024

(54) WALL PANEL OR CEILING PANEL

(71) Applicant: KKVV GMBH, BOTTROP (DE)

(72) Inventor: ANDREAS KOCZWARA, BOTTROP (DE)

(73) Assignee: KKVV GMBH, BOTTROP (DE)

(21) Appl. No.: 18/640,019

(22) Filed: Apr. 19, 2024

(30) Foreign Application Priority Data
Apr. 20, 2023 (DE) 20 2023 102 061.5

(51) Int. Cl. E04F 13/08; E04F 13/10; E04F 13/12; E04F 13/14; E04F 13/18

(52) U.S. Cl. CPC E04F 13/0866; E04F 13/0871; E04F 13/10; E04F 13/12; E04F 13/147; E04F 13/18

(57) ABSTRACT

A wall panel or a ceiling panel includes a rear wall which is made of a plastic, and a decorative layer which is arranged directly on the rear wall.

### CROSS REFERENCE TO PRIOR APPLICATIONS

Priority is claimed to German Patent Application No. DE 20 2023 102 061.5, filed Apr. 20, 2023. The entire disclosure of said application is incorporated by reference herein.

### FIELD

The present invention relates to a wall panel or to a ceiling panel having a rear wall and a decorative layer.

### BACKGROUND

Wall panels and ceiling panels are increasingly used in the design of interiors, where they are primarily used for decorative purposes, but wall panels and ceiling panels can also perform certain functions in the room. Wall panels and ceiling panels are typically constructed in multiple parts and have a rear wall via which the wall panel or ceiling panel is secured. A decorative layer faces towards the room and serves a decorative purpose or is even intended for a certain function, such as sound absorption.

Wall panels and ceiling panels in which the decorative layer is mounted on a wood fiberboard have previously been described. The wood fiberboard either forms the rear wall or is in turn mounted on a rear wall.

The weight of wall panels and ceiling panels is always crucial. This has an impact on handling when the wall panel or ceiling panel is being installed, but also when the wall panel or ceiling panel is being transported and presented for sale.

### SUMMARY

An aspect of the present invention is to provide a wall panel or a ceiling panel which is considerably more lightweight than a wall panel or a ceiling panel from the prior art and which can also be produced expediently and easily.

In an embodiment, the present invention provides for a wall panel or a ceiling panel which includes a rear wall which is made of a plastic, and a decorative layer which is arranged directly on the rear wall.

### BRIEF DESCRIPTION OF THE DRAWINGS

The present invention is described in greater detail below on the basis of embodiments and of the drawings in which:

FIG. 1 shows a sectional schematic view of a wall panel or a ceiling panel according to an exemplary embodiment of the present invention;

FIG. 2 shows a sectional schematic view of a wall panel or a ceiling panel according to an exemplary embodiment of the present invention;

FIG. 3 shows a sectional schematic view of a wall panel or a ceiling panel according to an exemplary embodiment of the present invention;

FIG. 4 shows a schematic view of a wall panel or a ceiling panel according to an exemplary embodiment of the present invention;

FIG. 5 shows a sectional schematic view of a wall panel or a ceiling panel according to an exemplary embodiment of the present invention; and

FIG. 6 shows a sectional schematic view of a detail of a wall panel or a ceiling panel according to an exemplary embodiment of the present invention.

### DETAILED DESCRIPTION

The wall panel or ceiling panel according to the present invention has a rear wall which is made of a plastic. The present invention provides that the decorative layer is placed directly on this rear wall. In other words, the wall panel or the ceiling panel according to the present invention does not have a ply of wood fibers, for example, an MDF ply. This results in a considerable weight advantage compared to the wall panels and the ceiling panels which are known from the prior art. The present invention is in particular based on the fact that the structure of the wall panel or the ceiling panel is considerably simplified, with the conventional and traditional type of structure comprising MDF as support material being rejected.

Within the meaning of the present invention, the “decorative layer” is an optically-functional layer. The decorative layer can thus, in addition to providing optical effects such as minimizing light reflections, also comprise functional effects, such as sound absorption or bonding functions. It is conceivable for the decorative layer to have a matte surface for reducing light reflections, for example, in the form of a board, and a magnetically active part, which is realized in the form of a layer between the surface and the rear wall. In other words, the “decorative layer” within the meaning of the present invention may have one ply or multiple plies. It is also conceivable for the decorative layer to not be in the form of a layer, but to instead comprise individual elements, such as a decorative material, for example, individual (art) prints, which are mounted on the rear wall via a holding structure. Such a decorative layer is also placed directly on the rear wall if there is no ply, in particular no ply of wood fibers, placed between the optically-functional decorative layer and the rear wall.

The present invention in particular provides that the rear wall does not comprise any wood fibers. Wood fibers would make the rear wall heavier, which is advantageously avoided according to this embodiment. The rear wall does not in particular have a wood fiberboard.

An embodiment of the present invention provides that the rear wall can, for example, comprise plastics fibers; the rear wall can, for example, consist of plastics fibers. Plastics fibers make the rear wall even more lightweight than would be the case with a solid rear wall. The plastics fibers may, for example, be spun-bond fibers or melt-blown fibers. It is conceivable, for example, for the plastics fibers to be produced by melt spinning, electrospinning, wet spinning, or matrix spinning. A feedstock, for example in the form of plastics flakes or granular plastic, is provided therefor, is dried, and is then extruded through spinning dies. The extruded fibers can then be drawn, shaped, cut and/or pressed. It is conceivable for the plastics fibers to be joined together in the form of a non-woven material to form the rear wall. Provision can, for example, be made for the rear wall to have a felt-like structure. A felt-like structure comprises fibers which adhere to one another. It is conceivable, for example, for the fibers of the felt-like structure to be hydro-entangled or to be partially fused to one another. It is also conceivable for the rear wall to have a fleece-like structure. Fibers of a fleece-like structure are intertwined, for example, by needling, in particular by spun-lacing, such that the fibers firmly bind together. It is in particular conceivable for the rear wall to have a felt-like and a fleece-like structure. It is further conceivable for the rear wall to have a moss-like structure. A particularly effective sound insulation is possible via this structure.

Provision can, for example, be made for the rear wall to be in one piece. A one-piece rear wall advantageously increases the stability of the wall panel or the ceiling panel and facilitates a high-precision production. “In one piece” within the meaning of the present invention means that the rear wall is manufactured as a single part from a single piece. It is conceivable for the rear wall to be cast, in particular to be cast into shape, for example, via injection molding. It is also conceivable, however, for the rear wall to be brought into shape by removal of material, for example, to be cut and/or milled. It is also conceivable, however, for the rear wall to be pressed into shape. Within the meaning of the present invention, “in one piece” also means that the rear wall can be produced from a multiplicity of plastics fibers. The feature “in one piece” within the meaning of the present invention in fact means that the rear wall is not formed of individual plies, in particular individual plies of different materials.

A further embodiment of the present invention provides that the plastic can, for example, be a recycled plastic, thereby making the wall panel or ceiling panel much more sustainable. It is thus conceivable, for example, for the rear wall to be at least partially produced from recycled plastics bottles.

The plastic can, for example, be PET. PET is a material which, in particular in the field of furniture production and in the field of surface finishing for interiors, has virtually not been considered at all to date either for use with furniture or for use as a substrate for parquet flooring or laminates, since PET is generally considered to be incapable of supporting the required mechanical loads. The use of PET in this case therefore overcomes a long-held technical prejudice and enables an inexpensive, more lightweight base with excellent availability for the rear wall of a wall panel or a ceiling panel.

To fasten the decorative layer on the rear wall, the present invention in particular provides for the decorative layer to be adhesively bonded to the rear wall over some or all of its surface area. This provides an effective connection between the decorative layer and the rear wall, without it being necessary to have the decorative layer or the rear wall machined. It is also conceivable, however, for the decorative layer to be stapled, clipped, fastened with expansion bolts, nailed, screwed, or clamped.

A further preferred embodiment of the present invention provides for the decorative layer to comprise wood and, for example, be a veneer. As an alternative thereto, the present invention provides that the decorative layer can, for example, comprise stone and in particular be a stone veneer. This results in the option of providing visually appealing wall boards or ceiling paneling. It is also conceivable, however, for the decorative layer to comprise or be a plastics layer. It is in particular conceivable for a decoration to be printed on the decorative layer.

It is possible for the decorative layer to alternatively or additionally comprise a metal, for example, to be a metal layer. This advantageously makes it possible to use the wall panel or ceiling panel magnetically, for example, in order to fasten notes to the wall panel or ceiling panel via a magnet. It is conceivable, for example, for the decorative layer to comprise a metal layer on which a wood layer, laminate layer or plastics layer is placed. A wall panel or a ceiling panel with the visual appearance of wood can thus, for example, also be used magnetically.

As an alternative or additionally, it is provided that the decorative layer comprises a moss-like structure. It is, for example, provided that the moss-like structure is a moss and/or an artificial moss. This makes it possible to have a positive effect on the climate and the sound in the room.

It is alternatively or additionally provided that the decorative layer comprises a laminate. The laminate may, for example, retain a visual appearance of wood or stone. A laminate is expedient, low-maintenance, and visually appealing. It is also conceivable for the decorative layer to comprise a cork layer or to be a cork layer.

It is alternatively or additionally provided that the decorative layer comprises a slate layer and/or a layer for use as a board. It is also conceivable for the decorative layer to comprise a leather layer, for example, an artificial or genuine leather layer. It is also conceivable for the decorative layer to comprise a glass layer and/or a mirror layer.

It is in particular provided that the thickness of the rear wall at least partially be between 4 mm and 15 mm, for example, 9 mm, and that the thickness of the decorative layer be between 0.5 mm and 100 mm. If the decorative layer comprises a moss-like structure, it is in particular provided that the thickness of the decorative layer is on average 10 mm or thicker, for example, 50 mm. If the decorative layer does not comprise a moss-like structure, it is in particular provided that the thickness of the decorative layer is 1 mm to 5 mm.

In order to provide the wall panel or ceiling panel with a design which is appealing, and which is conducive to absorbing sound, it can, for example, be provided that parallel grooves be arranged in the rear wall. The decorative layer is in this case arranged only between the grooves on the rear wall. Provision can, for example, be made for the grooves to have a rectangular cross section. It is also conceivable, however, that the grooves have a semicircular, a semi-elliptical or a V-shaped cross section. Provision is in particular made for the grooves to be milled into the rear wall. It is conceivable for the grooves to be milled into the rear wall and into the decorative layer. It is also conceivable, however, for the grooves to firstly be milled into the rear wall and for the decorative layer to be applied to the regions between the grooves. Provision can, for example, be made for the rear wall to be colored. This results in a visual contrast between the grooves and the decorative layer. In order to combine good sound absorption with a pleasing visual appearance, provision can, for example, be made for the width of the grooves to be between 2 mm and 25 mm, in particular between 10 mm and 15 mm, and for the regions between the grooves to be at a distance of between 50 mm and 10 mm, in particular between 35 mm and 25 mm, from one another. For this purpose, provision can, for example, also be made for the thickness of the rear wall in the region between the grooves to be between 6 mm and 20 mm, for example, to be approximately 9 mm, and for the thickness in the region of the grooves to be between 3 mm and 10 mm, in particular 5.5 mm. The thickness of the decorative layer can, for example, be between 0.5 mm and 3 mm, and in particular 1 mm.

Further details, features and advantages of the present invention emerge from the drawings and from the description below of embodiments with reference thereto. The drawings thereby merely illustrate exemplary embodiments of the present invention and are in no way intended to restrict the inventive concept.

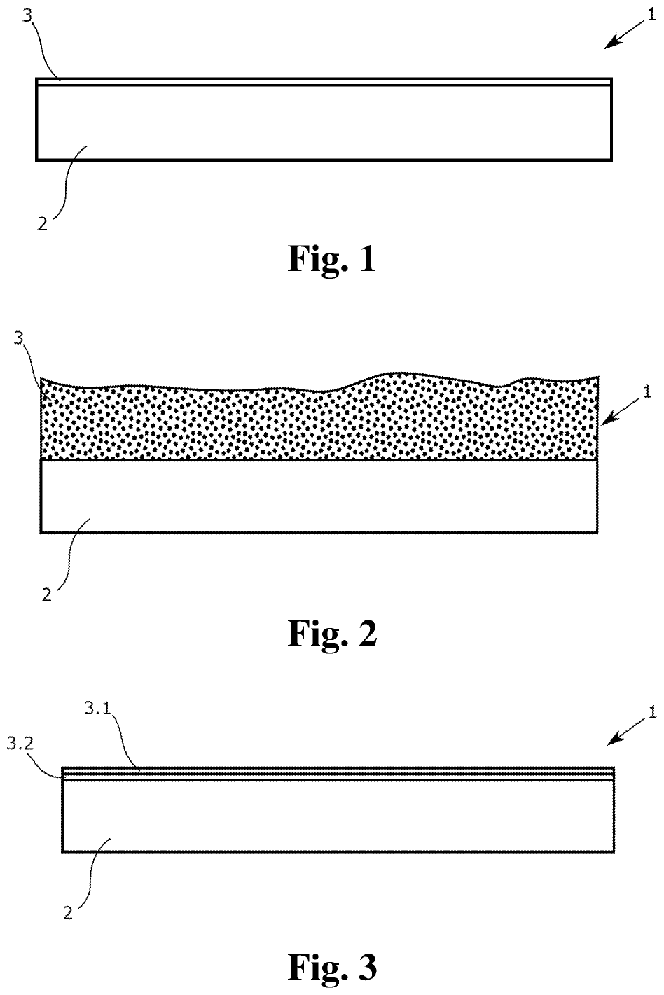

FIGS. 1-3 and 5 each show a sectional schematic view of a wall panel or a ceiling panel 1 according to an exemplary embodiment of the present invention. A wall panel or a ceiling panel 1 is intended to be mounted on a wall or a ceiling and performs decorative and/or functional tasks depending on the configuration. To this end, a decorative layer 3 is applied to a rear wall 2 of the wall panel or the ceiling panel 1. In the embodiments here shown, the decorative layer 3 is adhesively bonded to the rear wall 2 of the wall panel or the ceiling panel 1 over all its or over some of its surface area.

To save on costs and weight and thus improve the handling of the wall panel or the ceiling panel 1, it is provided that the decorative layer 3 is placed directly on the rear wall 2. In contrast to the prior art, no wood fiberboard, in particular no MDF board, is provided between the decorative layer 3 and the rear wall 2. The rear wall 2 also does not comprise any wood fibers. The wall panel or ceiling panel 1 according to the present invention is thus very lightweight compared to previously described wall panels and ceiling panels.

The rear wall 2 of the illustrated wall panel or ceiling panel 1 is made from plastics fibers which were obtained from recycled PET. Plastics fibers of recycled PET are inexpensive and very lightweight. It is conceivable to use disposable bottles to obtain the PET. This makes a significant contribution to the sustainability of the wall panel or the ceiling panel 1.

The wall panel or ceiling panel 1 shown in FIG. 1 has a rear wall 2 with a thickness of 9 mm and a decorative layer 3 with a thickness of 1 mm. The decorative layer 3 is a veneer, for example, a wood veneer or a stone veneer, a laminate, or a printed plastics layer. It is also conceivable for the decorative layer 3 to be a metal layer. This also makes it possible to use the wall panel or ceiling panel 1 magnetically, for example, as a magnetic pinboard. The decorative layer 3 may, however, also comprise a slate layer or a layer for use as a board. FIG. 2 illustrates another embodiment of the wall panel or the ceiling panel 1 in which the decorative layer 3 has a moss-like structure. This moss-like structure may comprise moss or artificial moss and is considerably thicker than the decorative layer 3 shown in FIG. 1. FIG. 3 shows a two-part decorative layer 3, in which case a functional layer 3.2 is arranged under an optical layer 3.1, which can, for example, comprise a veneer or a laminate. The functional layer 3.2 may be a metal layer. This makes the wall panel or the ceiling panel 1 magnetic despite having a non-metallic surface.

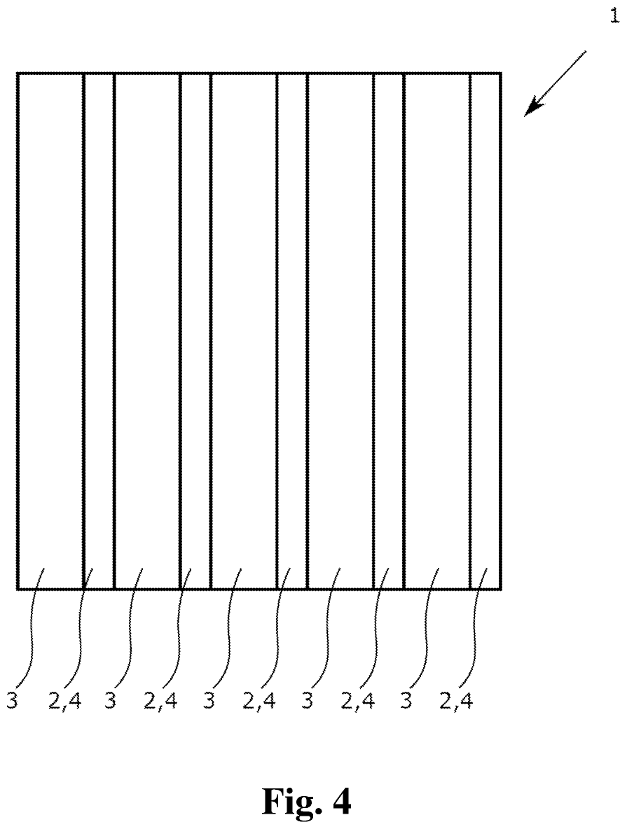

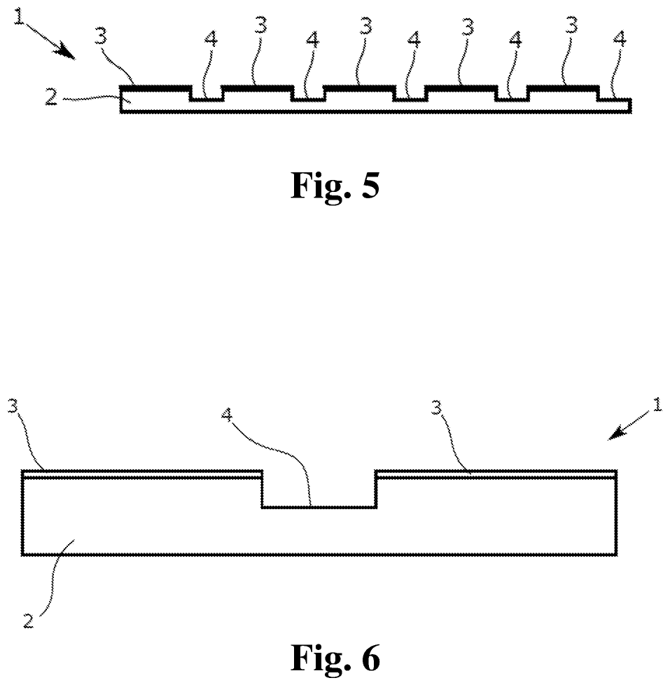

FIG. 4 shows a schematic top view of a wall panel or a ceiling panel 1 according to an exemplary embodiment of the present invention. A structuring of the wall panel or the ceiling panel 1 with parallel grooves 4 is thereby shown. The parallel grooves 4 can also readily be seen in the sectional views of the wall panel or ceiling panel 1 in FIGS. 5 and 6.

The plastic of the rear wall 2 of the wall panel or ceiling panel 1 shown in FIGS. 4-6 is microscopically shaped to absorb sound. This microscopic shape is not illustrated in the drawings, but can be achieved, for example, via a felt-like, a fleece-like or a moss-like microscopic shape of the plastic. The wall panel or ceiling panel 1 shown in FIGS. 4-6 can thus be used as an acoustic panel.

The macroscopic shape of the single-part rear wall 2 of the wall panel or ceiling panel 1 shown in FIGS. 4-6 is such that parallel grooves 4 are provided in the rear wall 2 at regular intervals. In the shown exemplary embodiments, the width of the grooves 4 is 13 mm. In the shown embodiments, the thickness of the rear wall 2 is 5.5 mm in the region of the grooves 4. In the case of the wall panel or ceiling panel 1 shown, the intervals between the grooves 4 are in each case 27 mm. Between the grooves 4, the thickness of the rear wall 2 is here 9 mm. The grooves 4 here illustrated have a rectangular cross section. It is also conceivable, however, for the grooves 4 to have a semicircular, a semi-oval-shaped or a V-shaped cross section.

The decorative layer 3 is applied in the regions between the grooves 4, for example, adhesively bonded or fused, directly to the rear wall 2. No wood fiberboard, for example an MDF board, is mounted between the decorative layer 3 and the rear wall 2. The decorative layer 3 is placed directly on the rear wall 2, which is produced from recycled PET.

The present invention is not limited to embodiments described herein; reference should be had to the appended claims.

### LIST OF REFERENCE NUMERALS

| | |
|---|---|
| 1 | Wall panel or ceiling panel |
| 2 | Rear wall |
| 3 | Decorative layer |
| 3.1 | Optical layer |
| 3.2 | Functional layer |
| 4 | Groove |

What is claimed is:

1. A wall panel or a ceiling panel comprising:
a rear wall which is made of a plastic; and
a decorative layer which is arranged directly on the rear wall.

2. The wall panel or the ceiling panel as recited in claim 1, wherein the plastic of the rear wall comprises plastics fibers.

3. The wall panel or the ceiling panel as recited in claim 1, wherein the plastic of the rear wall consists of plastics fibers.

4. The wall panel or the ceiling panel as recited in claim 1, wherein the plastic of the rear wall is a recycled plastic.

5. The wall panel or the ceiling panel as recited in claim 1, wherein the plastic of the rear wall is PET.

6. The wall panel or the ceiling panel as recited in claim 1, wherein the decorative layer is adhesively bonded to the rear wall over all or over a portion of a surface area of the decorative layer.

7. The wall panel or the ceiling panel as recited in claim 1, wherein the decorative layer comprises a wood or a stone.

8. The wall panel or the ceiling panel as recited in claim 7, wherein the wood is a veneer and the stone is a stone veneer.

9. The wall panel or the ceiling panel as recited in claim 1, wherein the decorative layer comprises a metal.

10. The wall panel or the ceiling panel as recited in claim 9, wherein the metal is a metal layer.

11. The wall panel or the ceiling panel as recited in claim 1, wherein the decorative layer comprises a moss-like structure.

12. The wall panel or the ceiling panel as recited in claim 11, wherein the moss-like structure is at least one of a moss and an artificial moss.

13. The wall panel or the ceiling panel as recited in claim 1, wherein the decorative layer comprises at least one of a laminate, a slate layer, a layer for use as a board, a leather layer, a glass layer, and a mirror layer.

14. The wall panel or the ceiling panel as recited in claim 1, wherein,
the laminate has a visual appearance of a wood or a stone, and
the leather layer is an artificial leather layer or a genuine leather layer.

15. The wall panel or the ceiling panel as recited in claim 1, wherein,
the rear wall has a thickness which is at least partially between 4 mm and 15 mm, and
the decorative layer has a thickness of at least 0.5 mm.

16. The wall panel or the ceiling panel as recited in claim 15, wherein,
the thickness of the rear wall is 9 mm, and
the thickness of the decorative layer is between 0.5 mm and 100 mm.
